(19) United States
(12) Patent Application Publication
(10) Pub. No.: US 2014/0365968 A1
(43) Pub. Date: Dec. 11, 2014

(54) Graphical User Interface Elements

(71) Applicant: Apple Inc., Cupertino, CA (US)

(72) Inventors: Jason Clay Beaver, San Jose, CA (US); Marian E. Goldeen, Three Rivers, CA (US); Luke Theodore Hiesterman, San Francisco, CA (US); Peter L. Hajas, Sunnyvale, CA (US)

(21) Appl. No.: 14/292,864

(22) Filed: May 31, 2014

Related U.S. Application Data
(60) Provisional application No. 61/832,738, filed on Jun. 7, 2013.

(51) Int. Cl. G06F 3/0482; G06F 3/0484; G06F 3/0481

(52) U.S. Cl. CPC G06F 3/0482; G06F 3/04815; G06F 3/04847
USPC 715/830

(57) ABSTRACT

A system, method and computer-readable medium are disclosed for generating and animating GUI elements.

### CROSS-REFERENCE TO RELATED APPLICATION

This application claims priority to U.S. Provisional Application No. 61/832,738, entitled “Graphical User Interface Elements,” filed on Jun. 7, 2013, the entire contents of which are incorporated herein by reference.

### TECHNICAL FIELD

This disclosure relates generally to graphical user interface elements.

### BACKGROUND

A graphical user interface (GUI) allows users to interact with electronic devices using images. GUIs can be used in computers, hand-held devices (e.g., smart phones, electronic tablets), portable media players or gaming devices, navigation systems, kiosks, household appliances and many other electronic devices used in the home or in industry. A GUI represents the information and actions available to a user through graphical icons and other GUI elements, which may be static or animated.

### SUMMARY

A system, method and computer-readable medium are disclosed for generating and animating GUI elements.

In some implementations, a method comprises: displaying, in a graphical user interface, an element for selecting date and time, where the element is drawn in the graphical user interface with a three-dimensional perspective; receiving user input selecting a rotatable portion of the element; animating the selected portion to simulate rotation; determining that content is displayed in a selection band of the element; and magnifying the content in the selection band.

In some implementations, a method comprises: displaying, in a graphical user interface, a table view including one or more cells; detecting a swipe gesture directed to a cell; animating the cell to slide in the direction of the swipe and to expose elements; receiving input selecting an element; and initiating an action based on the selected element.

In some implementations, a method comprises: displaying, in a graphical user interface, a table view including one or more cells; receiving input directed to adding or deleting a cell; moving content from a first buffer to second buffer, where the first buffer is used to render the table view; blurring the content in the second buffer; compositing overlapping cells on the blurred content, wherein a first cell of the composited cells overlies a second cell that is being added or deleted, wherein an opacity of the first cell is adjusted relative to the second cell; moving composited content from the second buffer to the first buffer; and rendering the first buffer contents to generate the table view.

In some implementations, a method comprises: displaying, in a graphical user interface (GUI), a first view with a selectable element for transitioning into a second view; receiving input directed to the selectable element; overlapping a first text string representing a label of the selectable element with a second text string representing a title of the second view; reducing a width of the wider of the first text string and the second text string; and animating the overlapped text strings to simulate a transition of the label from a first position in the GUI to a second position in the GUI, the animating including increasing the width of the overlapped text strings while applying a cross-fading effect to the overlapped text strings.

Particular implementations disclosed herein provide one or more of the following advantages. The disclosed GUI elements represent information and actions available to a user through animated and intuitive GUI elements, thus allowing the user to more easily navigate a GUI.

Other implementations are disclosed for systems, methods and computer-readable mediums. The details of the disclosed implementations are set forth in the accompanying drawings and the description below. Other features, objects, and advantages will be apparent from the description and drawings and from the claims.

### DESCRIPTION OF DRAWINGS

FIG. 1 illustrates an example GUI element for picking a date and time.

FIG. 2 is a flow diagram of an example animation process for the GUI element of FIG. 1.

FIGS. 3A and 3B illustrate an example GUI element that reveals one or more options in response to a swipe gesture.

FIG. 4 is a flow diagram of an example animation process for the GUI element of FIGS. 3A and 3B.

FIGS. 5A-5D illustrate an example animation process for a GUI element.

FIG. 6 is a flow diagram of the example animation process of FIGS. 5A-5D.

FIGS. 7A-7G illustrate an example animation process for a GUI element.

FIG. 8 is a flow diagram of the animation process for the GUI element of FIGS. 7A-7G.

FIG. 9 is a block diagram of an exemplary device architecture for implementing the GUI elements described in reference to FIGS. 1-8.

The same reference symbol used in various drawings indicates like elements.

### DETAILED DESCRIPTION

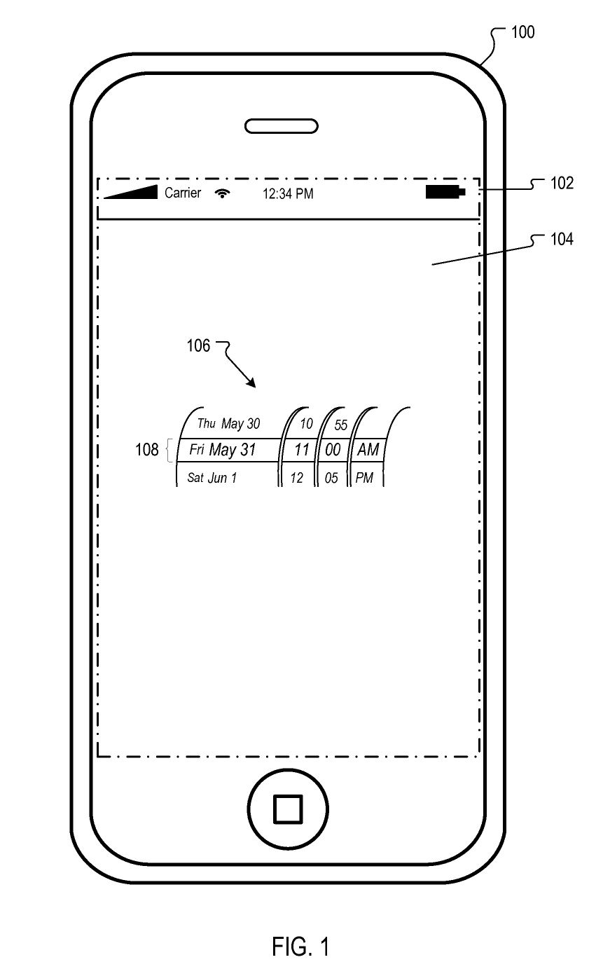

FIG. 1 illustrates an example GUI element 106 (hereafter “picker element”) for picking date and time. In some implementations, picker element 106 can display text or images other than date and time.

In some implementations, picker element 106 is presented in GUI 104 on display screen 104 of mobile device 100. Display screen 104 can be a touch sensitive surface that is responsive to touch input and gestures. Mobile device 100 can be any device capable of displaying a GUI, including but not limited to a smart phone, media player, electronic tablet, portable computer, game console, wearable device, television, digital camera, video recorder, multimedia system and navigation system.

In some implementations, picker element 106 is a cylinder drawn in a three-dimensional perspective by a graphics system of mobile device 100. Responsive to input, a rotatable section of picker element 106 is animated by the graphics system to appear to rotate. For example, when a user touches, swipes or flicks a rotatable section of picker element 106, the section rotates about an imaginary axis that is parallel with display screen 102. The section rotates as if it had inertia and was subject to friction forces. An audio file can be played during rotation, such as a clicking noise. An example graphics system capable of displaying picker element 106 is Core Animation, developed and distributed by Apple Inc., Cupertino Calif., USA or OpenGL managed by Khronos Group, Beaverton, Oreg., USA.

In the example shown, picker element 106 includes four sections that can be rotated independently of each other, in either direction, by a user's touch or gesture (e.g., a flick or swipe gesture). The user can select a date and time by rotating each section until the desired date and time is displayed in selection band 108. Content displayed in selection band 108 is animated to appear magnified to improve readability of the date and time.

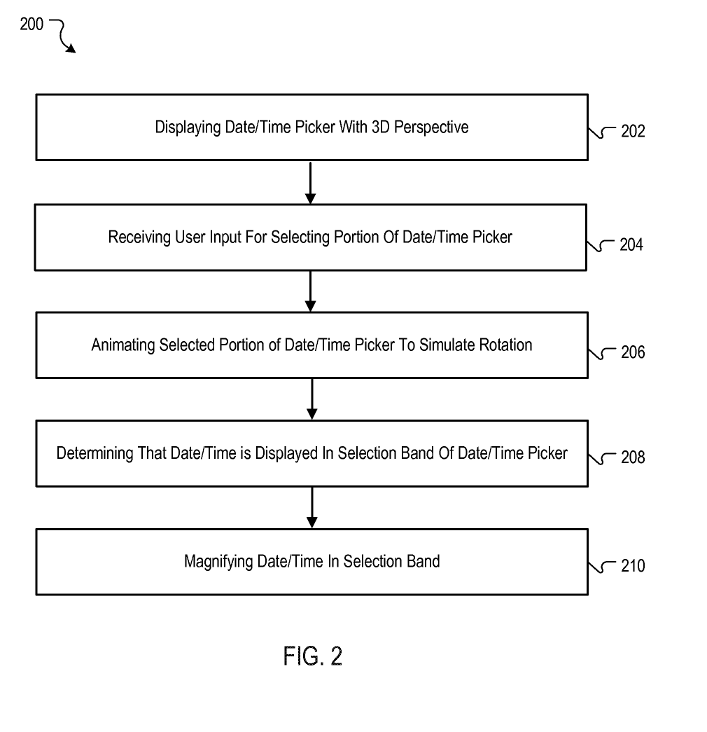

FIG. 2 is a flow diagram of an example animation process for the element 106 of FIG. 1. In some implementations, process 200 can begin by displaying the picker element in a 3D perspective (202). Process 200 can continue by receiving input for selecting a section of the date picker (204). The input can be a touch or gesture provided by user. The input can also be provided programmatically by an application or by the user moving the mobile device (e.g., shaking the mobile device) or through a voice command. Process 200 can continue by, in response to the input, animating the selected section of the picker element to simulate rotation (206). Process 200 can continue by determining that a date and time is displayed in the selection band of the picker element (208). Process 200 can continue by magnifying the date and time in the selection band (210).

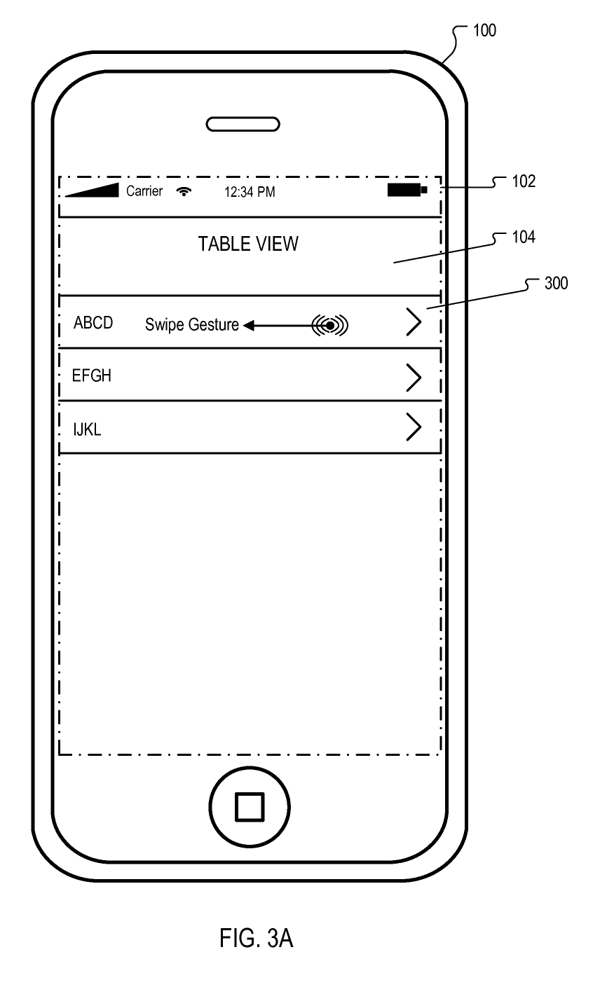

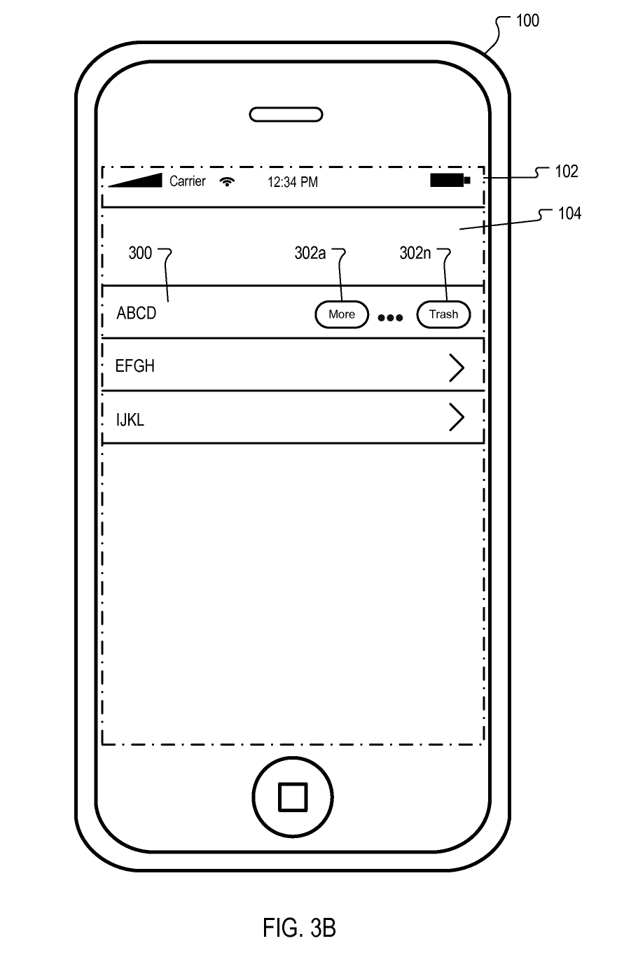

FIGS. 3A and 3B illustrate an example GUI element that reveals one or more elements in response to a swipe gesture. Referring to FIG. 3A, GUI 104 is a table view with multiple cells. In response to a user making a swipe gesture on cell 300 (from right to left), cell 300 is animated to expose elements 302a-302n (where n>1), as shown in FIG. 1B. Elements 302a-302n can be any GUI element, such as buttons, thumbnails, switches or other controls. In the example shown, two elements are shown. A “more” button opens another view that provides the use with more information related to cell 300. A “trash” button deletes cell 300 from the Table View.

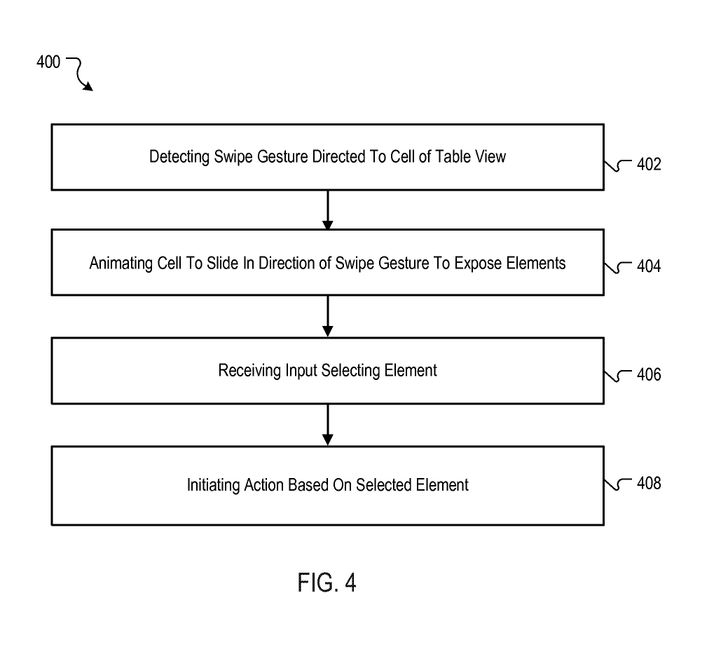

FIG. 4 is a flow diagram of an example animation process for the GUI element of FIGS. 3A and 3B. In some implementations, process 400 can begin by detecting a swipe gesture directed to a cell of table view (402). For example, the swipe gesture can be from right to left. Process 400 can continue by animating the cell to slide in the direction of the swipe gesture to expose two or more elements (404). For example, the cell can appear to slide from right to left exposing buttons that can be selected by a user. An element can be used to delete the cell, expose the user to additional information in another view, page, pane or menu, or any other desired function. Process 400 can continue by receiving input selecting an element (406), and, responsive to the selection, initiating an action based on the selected element (408). In some implementations, a swipe gesture from left to right can expose one or more elements.

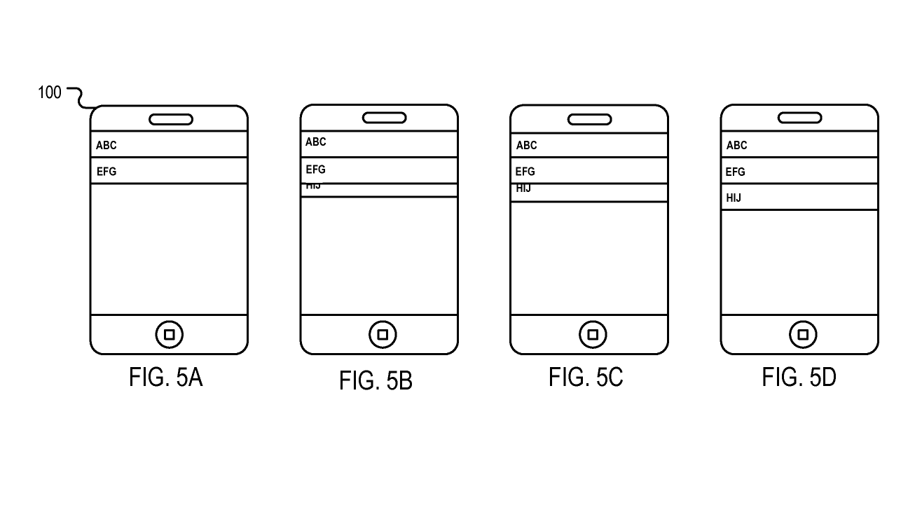

FIGS. 5A-5D illustrate an example animation process for a GUI element. In some implementations, cells can be added or deleted to a table view using animation. For example, an added cell with the label “HIJ” can appear to slide out from underneath the cell above (or below) with label “EFG.” In some implementations, it is desirable to have translucent cells overlying a blurred background. This effect can be achieved by blurring the background using a blurring filter and changing the opacity of the cells so that they are translucent. In some implementations, this effect can be achieved using alpha compositing techniques or other graphics system such as Core Animation or OpenGL. If the cells are translucent, the label of the added cell (“HIJ”) can be seen through the upper cell label (“EFG”) cell, which can be visually jarring. This problem is addressed by process 600 described below.

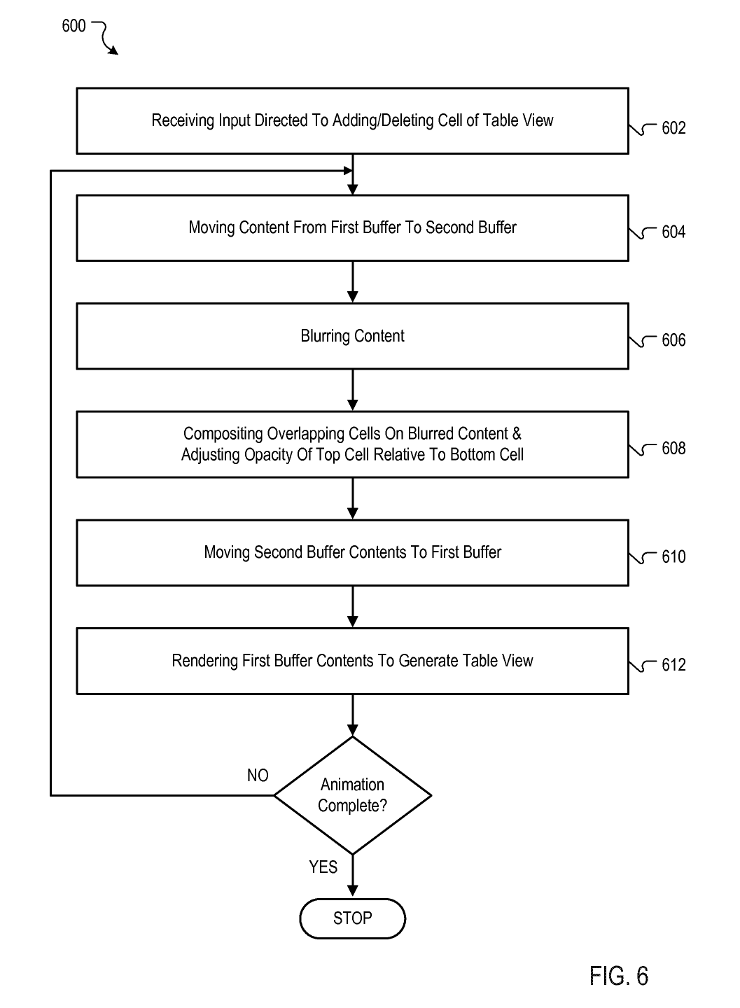

FIG. 6 is a flow diagram of the example animation process of FIGS. 5A-5D. Process 600 can begin by receiving input directed to adding or deleting a cell in a table view (602). In response to the input, process 600 animates the adding or deleting of cells over blurred background content by moving the background content from a first buffer (e.g., frame buffer) used to render the table view into second buffer (604), blurring the background content (606), compositing overlapping cells on the blurred background and adjusting the opacity of the top cell relative to the bottom cell (606), moving the second buffer contents to the first buffer (610) and rendering the first buffer contents to generate the table view. If the animation sequence is completed, process 600 stops. Otherwise, process 600 returns to step 604.

The steps described above prevent, during an animated transition to add or delete a cell, the label in the bottom cell (added or deleted cell) from being seen through the top cell where it can be occluded by the label in the top cell, resulting in a visually jarring appearance. Once the animated transition is completed, the cells appear translucent, such that the blurred background can be seen through the cells.

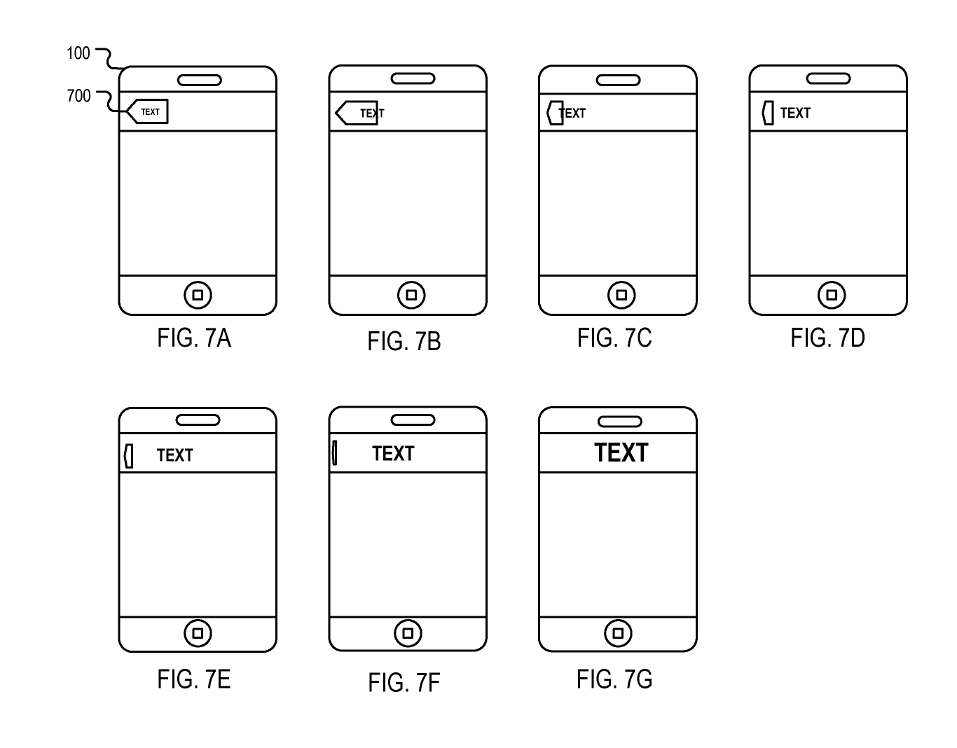

FIGS. 7A-7G illustrate an example animation process for a GUI element. In some implementations, it is desired to animate the label on a button to transition into a title of a view. For example, back button 700 for returning to a previous view of a GUI can have a label. When back button 700 is selected, the label on button 700 is animated to slide horizontally (from left to right) from a first position on button 700 to a second position in the view. Because the font and size of the text string used for the button label is different from the font and size of the text string used for the view title, the animation may appear visually jarring. Process 800 addresses this problem as described below.

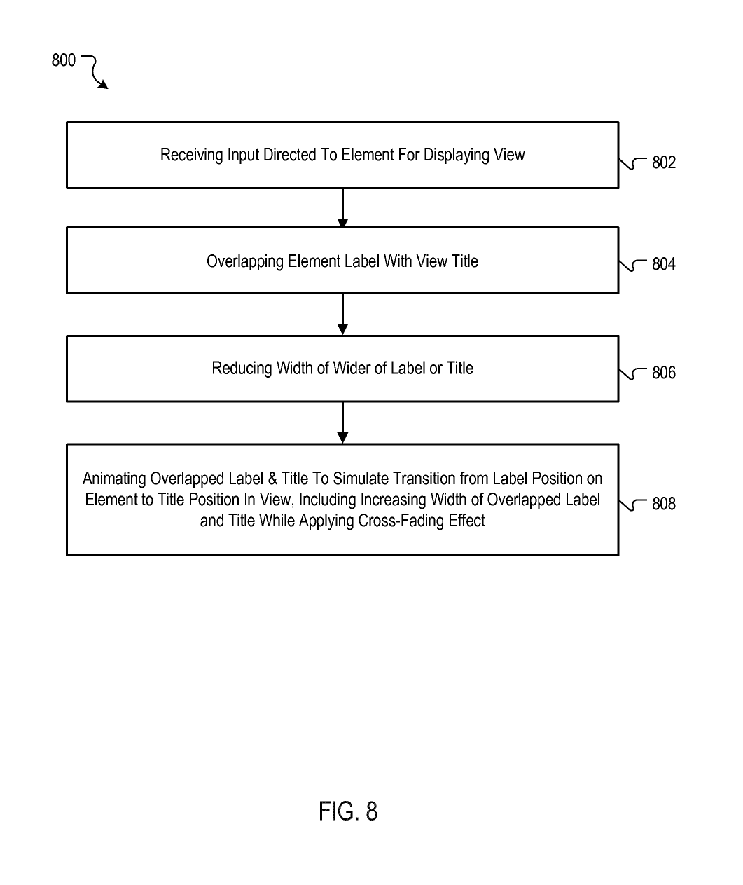

FIG. 8 is a flow diagram of the animation process for the GUI element of FIGS. 7A-7G. In some implementations, process 800 can begin by receiving input directed to an element for displaying a view (802). For example, the element can be a back button. Process 800 can continue by overlapping the text string for the element label with the text string for the view title (804). Process 800 can continue by reducing the width of the wider of the label or the title view text string so that the text strings are aligned (806). Process 800 can continue by animating the overlapped label and title to simulate a transition from the label position on the element to the title position in the view, including increasing the width of the overlapped label and title while applying a cross-fading effect (808).

### Example Device Architecture

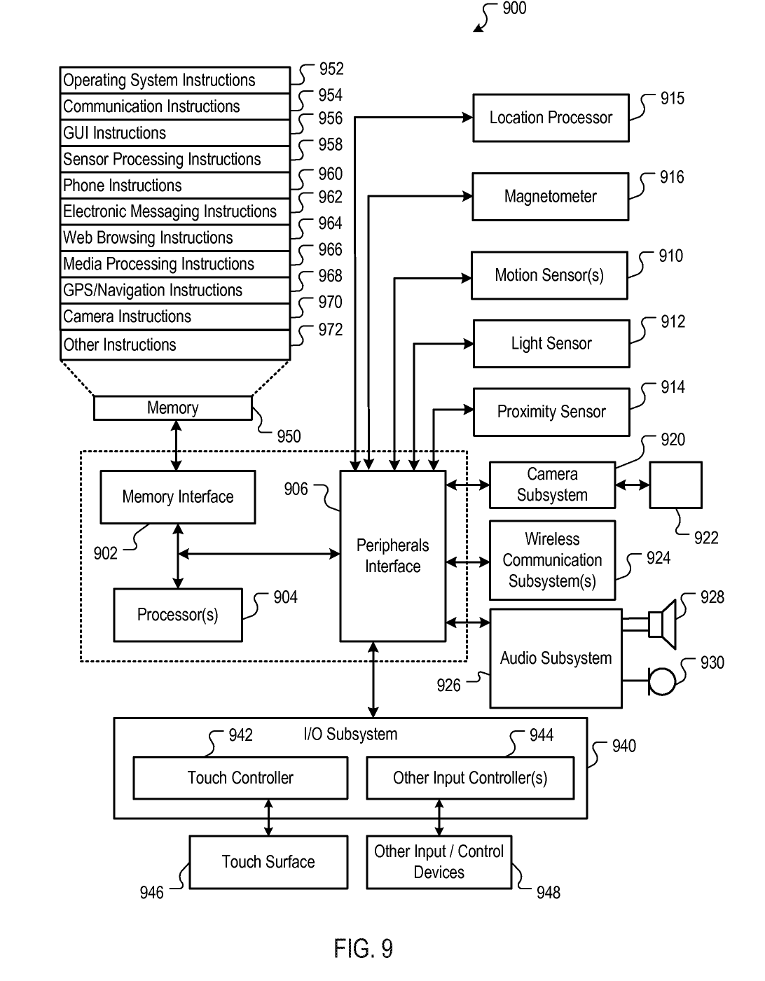

FIG. 9 is a block diagram of an exemplary architecture of a location-aware device capable of implementing the features and processes described in reference to FIGS. 1-8.

Architecture 900 may be implemented in any device for generating the features described in reference to FIGS. 1-8, including but not limited to portable or desktop computers, smart phones and electronic tablets, television systems, game consoles, kiosks and the like. Architecture 900 may include memory interface 902, data processor(s), image processor(s) or central processing unit(s) 904, and peripherals interface 906. Memory interface 902, processor(s) 904 or peripherals interface 906 may be separate components or may be integrated in one or more integrated circuits. One or more communication buses or signal lines may couple the various components.

Sensors, devices, and subsystems may be coupled to peripherals interface 906 to facilitate multiple functionalities. For example, motion sensor 910, light sensor 912, and proximity sensor 914 may be coupled to peripherals interface 906 to facilitate orientation, lighting, and proximity functions of the device. For example, in some implementations, light sensor 912 may be utilized to facilitate adjusting the brightness of touch surface 946. In some implementations, motion sensor 910 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 906, such as a temperature sensor, a biometric sensor, or other sensing device, to facilitate related functionalities.

Location processor 915 (e.g., GPS receiver) may be connected to peripherals interface 906 to provide geo-positioning. Electronic magnetometer 916 (e.g., an integrated circuit chip) may also be connected to peripherals interface 906 to provide data that may be used to determine the direction of magnetic North. Thus, electronic magnetometer 916 may be used as an electronic compass.

Camera subsystem 920 and an optical sensor 922, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 924. Communication subsystem(s) 924 may include one or more wireless communication subsystems. Wireless communication subsystems 924 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 924 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, and a Bluetooth™ network. Communication subsystems 924 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 926 may be coupled to a speaker 928 and one or more microphones 930 to facilitate voice-enabled functions, such as voice recognition, voice replication, digital recording, and telephony functions.

I/O subsystem 940 may include touch controller 942 and/or other input controller(s) 944. Touch controller 942 may be coupled to a touch surface 946. Touch surface 946 and touch controller 942 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 946. In one implementation, touch surface 946 may display virtual or soft buttons and a virtual keyboard, which may be used as an input/output device by the user.

Other input controller(s) 944 may be coupled to other input/control devices 948, such as one or more buttons, rocker switches, thumb-wheel, infrared port, USB port, and/or a pointer device such as a stylus. The one or more buttons (not shown) may include an up/down button for volume control of speaker 928 and/or microphone 930.

In some implementations, device 900 may present recorded audio and/or video files, such as MP3, AAC, and MPEG files. In some implementations, device 900 may include the functionality of an MP3 player and may include a pin connector for tethering to other devices. Other input/output and control devices may be used.

Memory interface 902 may be coupled to memory 950. Memory 950 may include high-speed random access memory or non-volatile memory, such as one or more magnetic disk storage devices, one or more optical storage devices, or flash memory (e.g., NAND, NOR). Memory 950 may store operating system 952, such as Darwin, RTXC, LINUX, UNIX, OS X, WINDOWS, or an embedded operating system such as VxWorks. Operating system 952 may include instructions for handling basic system services and for performing hardware dependent tasks. In some implementations, operating system 952 may include a kernel (e.g., UNIX kernel).

Memory 950 may also store communication instructions 954 to facilitate communicating with one or more additional devices, one or more computers or servers. Communication instructions 954 may also be used to select an operational mode or communication medium for use by the device, based on a geographic location (obtained by the GPS/Navigation instructions 968) of the device. Memory 950 may include graphical user interface instructions 956 to facilitate graphic user interface processing, including a touch model for interpreting touch inputs and gestures; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes; camera instructions 970 to facilitate camera-related processes and functions; and other instructions 972 for facilitating other processes, features and applications, such as the features and processes described in reference to FIGS. 1-8.

Each of the above identified instructions and applications may correspond to a set of instructions for performing one or more functions described above. These instructions need not be implemented as separate software programs, procedures, or modules. Memory 950 may include additional instructions or fewer instructions. Furthermore, various functions of the device may be implemented in hardware and/or in software, including in one or more signal processing and/or application specific integrated circuits.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
displaying, in a graphical user interface, an element for selecting date and time, where the element is drawn in the graphical user interface with a three-dimensional perspective;
receiving user input selecting a rotatable portion of the element;
animating the selected portion to simulate rotation;
determining that content is displayed in a selection band of the element; and
magnifying the content in the selection band,
where the method is performed by one or more hardware processors.

2. A method comprising:
displaying, in a graphical user interface, a table view including one or more cells;
detecting a swipe gesture directed to a cell;
animating the cell to slide in the direction of the swipe and to expose elements;
receiving input selecting an element; and
initiating an action based on the selected element,
where the method is performed by one or more hardware processors.

3. A method comprising:
displaying, in a graphical user interface, a table view including one or more cells;
receiving input directed to adding or deleting a cell;
moving content from a first buffer to second buffer, where the first buffer is used to render the table view;
blurring the content in the second buffer;
compositing overlapping cells on the blurred content, wherein a first cell of the composited cells overlies a second cell that is being added or deleted, wherein an opacity of the first cell is adjusted relative to the second cell;
moving composited content from the second buffer to the first buffer; and
rendering the first buffer contents to generate the table view,
where the method is performed by one or more hardware processors.

4. A method comprising:
displaying, in a graphical user interface (GUI), a first view with a selectable element for transitioning into a second view;
receiving input directed to the selectable element;
overlapping a first text string representing a label of the selectable element with a second string representing a title of the second view;
reducing a width of the wider of the first text string and the second text string; and
animating the overlapped text strings to simulate a transition of the label from a first position in the GUI to a second position in the GUI, the animating including increasing the width of the overlapped text strings while applying a cross-fading effect to the overlapped text strings,
where the method is performed by one or more hardware processors.

5. A system comprising:
one or more processors;
memory coupled to the one or more processors and configured for storing instructions, which, when executed by the one or more processors, causes the one or more processors to perform operations comprising:
displaying, in a graphical user interface, an element for selecting date and time, where the element is drawn in the graphical user interface with a three-dimensional perspective;
receiving user input selecting a rotatable portion of the element;
animating the selected portion to simulate rotation;
determining that content is displayed in a selection band of the element; and
magnifying the content in the selection band.

6. A system comprising:
one or more processors;
memory coupled to the one or more processors and configured for storing instructions, which, when executed by the one or more processors, causes the one or more processors to perform operations comprising:
displaying, in a graphical user interface, a table view including one or more cells;
detecting a swipe gesture directed to a cell;
animating the cell to slide in the direction of the swipe and to expose elements;
receiving input selecting an element; and
initiating an action based on the selected element.

7. A system comprising:
one or more processors;
memory coupled to the one or more processors and configured for storing instructions, which, when executed by the one or more processors, causes the one or more processors to perform operations comprising:
displaying, in a graphical user interface, a table view including one or more cells;
receiving input directed to adding or deleting a cell;
moving content from a first buffer to second buffer, where the first buffer is used to render the table view;
blurring the content in the second buffer;
compositing overlapping cells on the blurred content, wherein a first cell of the composited cells overlies a second cell that is being added or deleted, wherein an opacity of the first cell is adjusted relative to the second cell;
moving composited content from the second buffer to the first buffer; and
rendering the first buffer contents to generate the table view.

8. A system comprising:
one or more processors;
memory coupled to the one or more processors and configured for storing instructions, which, when executed by the one or more processors, causes the one or more processors to perform operations comprising:
displaying, in a graphical user interface (GUI), a first view with a selectable element for transitioning into a second view;
receiving input directed to the selectable element;
overlapping a first text string representing a label of the selectable element with a second string representing a title of the second view;
reducing a width of the wider of the first text string and the second text string; and
animating the overlapped text strings to simulate a transition of the label from a first position in the GUI to a second position in the GUI, the animating including increasing the width of the overlapped text strings while applying a cross-fading effect to the overlapped text strings.
